(19) United States
(12) Patent Application Publication
(10) Pub. No.: US 2006/0246394 A1
(43) Pub. Date: Nov. 2, 2006

(54) Endodontic files having improved lateral and torsional flexibility

(76) Inventors: Giuseppe Cantatore, Roma (IT); Arnaldo Castellucci, Florence (IT); Elio Vincenzo Giovanni Berutti, Torino (IT)

Correspondence Address: Paul H. Johnson;Gable & Gotwals, 10th Floor, 100 W. 5th Street, Tulsa, OK, 74103, US

(21) Appl. No.: 11/115,896

(22) Filed: Apr. 27, 2005

(51) Int. Cl. A61C 5/02

(52) U.S. Cl. 433/102

(57) ABSTRACT

A dental reamer/file instrument having an elongated shank having a proximal end portion, a distal end and an intermediate tapered working portion, the external surface of the shank working portion having three continuous equally spaced helical flutes forming three spiral flanges, each of which, in a plane perpendicular to the length of the shaft is defined in part by a triangular outer working portion having a base width of “A”, an apex of each triangular outer portion forming a cutting/scraping edge, each triangular outer working portion being integrally connected to the central core portion by a reduced width neck portion of width “B” and wherein “A” is greater than “B”, the triangular outer working portions being rotational flexibility within elastic limits relative to the shaft central core portion.

### REFERENCE TO PENDING APPLICATIONS

This application is not based upon any pending domestic or international patent applications and is not related to an invention resulting from federally sponsored research or development.

### BACKGROUND OF THE INVENTION

(1) Field of the Invention

The present invention relates to the field of endodontic instruments adapted for use in performing root canal therapy on teeth. The files of this invention are characterized by improved lateral as well as torsional flexibility.

(2) Description of Related Art

A major advancement in dentistry over the past few decades has been in endodontics, that is, the treatment of root canals. Before endodontics became readily available an abscessed tooth was invariably extracted as the only known procedure for alleviating the intense pain associated with an abscessed tooth. Since the advent of endodontics the necessity for extracting a tooth has greatly diminished which has had a dramatic impact on the practice of dentistry and upon the overall improvement of human health. By preserving natural teeth as individual's progress in age their prospects of good appearance and good health are greatly increased.

In root canal therapy, the crown of a diseased, abscessed or infected tooth is opened so to permit the root canal to be cleaned and then filled. Generally the procedure, after opening the crown, is to employ a series of flexible instruments or files which are used to clean out and shape the root canal. The root pulpal material of the tooth is removed. That is, after opening the crown, the endodonist must carefully extract the pulpal material to alleviate and prevent reinfection and at the same time to shape the root canal so as to receive a filler material, such as gutta-percha. For cleaning and reshaping the root canal, the normal procedure is the use of a dental file or, more likely, a series of dental files. Each file is manipulated, that is, rotated and reciprocated in the root canal by the endodonist. This can be done manually or by the insertion of the file within a hand piece by which the file is mechanically rotated with the manipulation of the hand piece being controlled by the endodonist.

Typically, files of increasingly larger diameter are used in sequence to achieve the desired cleaning and shaping. When the canal has been properly cleaned and shaped, it is filled with a filler material which typically comprises a waxy, rubbery compound known as gutta-percha, although other filler materials have been perfected. The invention herein is not concerned with filling the root canal after it is cleaned and prepared, but instead, the present invention is concerned with the configuration of endodontic files having improved lateral and torsional flexibility.

Root canals are seldom straight but on the contrary, the typical root canal is non-linear and can be configured in bends and turns. Further, the interior wall of the root canal is usually irregular. For these reasons, dental files are employed not only to remove pulpal material but to shape the wall of the root canal so that it can be more successfully treated by the deposition of filler material. For these reasons the files used to clean a root canal must be highly flexible to enable the endodonist to clean the root canal to the full depth thereof. In addition to being highly flexible, endodontic files are required to have torsional strength and capability to resist cyclic fatigue. For further background information relating to the subject matter of this invention and specifically relating to dental reamer/files reference may be made to the following previously-issued United States patents.

| PATENT | | | |
|---|---|---|---|
| NUMBER | INVENTOR(S) | ISSUE DATE | TITLE |
| 4,443,193 | Roane | Apr. 17, 1984 | Endodontic Instrument |
| 4,536,159 | Roane | Aug. 20, 1985 | Endodontic Instrument |
| 4,934,934 | Arpaio, Jr. et al. | Jun. 19, 1990 | Dental File/Reamer Instrument |
| 5,380,200 | Heath et al. | Jan. 10, 1995 | Endodontic Instrument Of Predetermined |
| | | | Flexibility |
| 5,464,362 | Heath et al. | Nov. 07, 1995 | Endodontic Instrument |
| 5,658,145 | Maillefer et al. | Aug. 19, 1997 | Set Of Instruments For Boring Dental |
| | | | Radicular Canals And Method Therefor |
| 5,692,902 | Aeby | Dec. 02, 1997 | Set Of Instruments For The Boring Of |
| | | | Radicular Dental Canals |
| 5,873,719 | Calas et al. | Feb. 23, 1999 | Dental Reamer |
| 5,897,316 | Buchanan | Apr. 27, 1999 | Endodontic Treatment System |
| 5,921,775 | Buchanan | Jul. 13, 1999 | Endodontic Treatment System |
| 5,975,899 | Badoz et al. | Nov. 02, 1999 | Dental Reamer |
| 6,012,921 | Riitano | Jan. 11, 2000 | Endodontic Systems For The Anatomical, |
| | | | Sectional And Progressive Corono-Apical |
| | | | Preparation Of Root Canals With Three Sets |
| | | | Of Dedicated Instruments |
| 6,074,209 | Johnson | Jun. 13, 2000 | Reduced Torque Endodontic File |
| 6,217,335 | Riitano et al. | Apr. 17, 2001 | Endodontic Systems And Methods For The |
| | | | Anatomicall, Sectional And Progressive |
| | | | Corono-Apical Preparation Of Root Canals |
| | | | With Minimal Apical Intrusion |
| 6,267,592 | Mays | Jul. 31, 2001 | Highly Flexible Instrument For Dental |
| | | | Applications |
| 6,312,261 | Mays | Nov. 06, 2001 | Endodontic Obturator With Removable |
| | | | Carrier And Method Of Use Thereof |
| 6,315,558 | Farzin-Nia et al. | Nov. 13, 2001 | Method Of Manufacturing Superelastic |
| | | | Endodontic Files And Files Made Therefrom |
| 6,390,819 | Riitano | May 21, 2002 | Endodontic Systems And Methods For The |
| | | | Anatomical, Sectional And Progressive |
| | | | Corono-Apical Preparation Of Root Canals |
| | | | With Dedicated Stainless Steel Instruments |
| | | | And Dedicated Nickel/Titanium Instruments |
| 6,419,488 | McSpadden et al. | Jul. 16, 2002 | Endodontic Instrument Having A Chisel Tip |
| 6,514,076 | Bleiweiss et al. | Feb. 04, 2003 | Precipitation Hardenable Stainless Steel |
| | | | Endodontic Instruments And Methods For |
| | | | Manufacturing And Using The Instruments |
| 6,520,774 | Mays | Feb. 18, 2003 | Highly Flexible Instrument For Medical |
| | | | Applications |
| 6,644,972 | Mays | Nov. 11, 2003 | Endodontic Obturator With Removable |
| | | | Carrier And Method Of Use Thereof |
| 6,746,245 | Riitano et al. | Jun. 08, 2004 | Methods For Cleaning And Shaping |
| | | | Asymmetrical Root Canals In An Anatomical |
| | | | Fashion |
| 2004/0121283 | Mason | Jun. 24, 2004 | Precision Cast Dental Instrument |
| 2002/0090594 | Riitano et al. | Jul. 11, 2002 | Methods For Cleaning And Shaping |
| | | | Asymmetrical Root Canals In An Anatomical |
| | | | Fashion |
| 2003/0077553 | Brock | Apr. 24, 2003 | Endodontic Instrument Having Notched |
| | | | Cutting Surfaces |
| 2004/0058297 | Danger | Mar. 02, 2004 | Root Canal Instrument |
| 2004/0043357 | Garman | Mar. 04, 2004 | Endodontic Instrument |
| 2004/0023186 | McSpadden | Feb. 05, 2004 | Multi-Tapered Endodontic File |
| 2003/0013067 | Bleiweiss et al. | Jan. 16, 2003 | Precipitation Hardenable Stainless Steel |
| | | | Endodontic Instruments And Methods For |
| | | | Manufacturing And Using The Instruments |
| Re. 34,439 | Heath | Nov. 09, 1993 | Dental Compactor Instrument |

### BRIEF SUMMARY OF THE INVENTION

A dental file instrument is the subject of this invention which may also be titled a “reamer.” Whether described as a “reamer” or “file,” the function is essentially the same—that is to clean and shape the root canal of a tooth to permit the tooth to receive a filler material. The invention will be described as a file with the understanding that it is inclusive of a reamer. The dental file of this invention has an elongated shank having a proximal end portion, a distal end and an intermediate working portion. The external surface of the shank working portion has three continuous, equally spaced, helical flutes formed into a central core of the shank working portion. The spaced apart helical flutes form therebetween three integral spiral flanges, each of which is, in planes perpendicular to the length of the shaft, shaped in part by a triangular outer portion. The triangular outer portion of each spiraled flange has, in cross sections taken perpendicular to the length of the file, a base width of (A). Each of the triangular portions has an apex that forms a cutting/scraping edge. The triangular outer portion of each spiraled flange is integrally connected to the shaft's central core by a reduced width neck portion having a width (B). In the invention herein the width (A) of the triangular outer portion of each spiraled flange is greater than the width (B) of the connecting neck portion. The triangular outer portion of each spiraled flange is therefore rotationally flexible relative to the shaft's inner core portion and the spiraled helical flutes provide longitudinal flexibility. Thus, because of the unique cross-sectional configuration of the shaft working portion both improved lateral and torsional flexibility are obtained.

Further objects and features of the present invention will be apparent to those skilled in the art upon reference to the accompanying drawings and upon reading the following description of the preferred embodiments.

### BRIEF DESCRIPTION OF THE DRAWINGS

FIG. 1 is an elevational view of an endodontic file that incorporates the principles of this invention. The endodontic file has a proximal end that receives a handle, or that could be configured to be received in a hand piece by which it is rotated, a distal end and an intermediate working portion. The invention is in the external configuration of the working portion.

FIG. 2 is an enlarged fragmentary elevational view taken from FIG. 1 showing helical flutes and helical spiraled integral flanges formed on the exterior surface of the file working portion.

FIG. 3 is an enlarged cross sectional view of the file working portion of FIGS. 1 and 2.

In this Figure the helical flutes formed in the external surface of the file working portion of the relatively shallow depth.

FIG. 4 is a cross-sectional view as in FIG. 3 but wherein the spiraled helical flutes are of greater depth. By dotted outline bending of the narrow neck portions of the spiraled flanges are illustrated to show the file's torsional flexibility.

FIG. 5 is a cross sectional view as in FIGS. 3 and 4 but showing an embodiment in which the helical flutes are of greater depth and that therefore provide greater torsional flexibility. In this view the outer ends of the triangular shaped spiraled flanges form an acute angle.

FIG. 6 is a view of FIGS. 3 through 5 showing the arrangement wherein the outer ends of each of the flange portions is bound by a 90 degree angle.

FIG. 7 shows the embodiment as in FIG. 6 but wherein the outer ends of the triangular shaped spiral flanges form an obtuse angle.

### DETAILED DESCRIPTION OF THE INVENTION

The invention will be described by reference to the drawings using numbers assigned to elements according to the following table:

| | |
|---|---|
| 10 | dental file |
| 12 | shank |
| 14 | proximal portion |
| 16 | distal end |
| 18 | working portion |
| 20 | handle |
| 22A, B, & C | helical flutes |
| 24 | cylindrical portion of 12 |
| 26A, B & C | spiral flanges neck portion |
| 28 | central core |
| 30 | flange working portion |
| 32 | flange outer surfaces |
| 34 | tip-spiral edge |

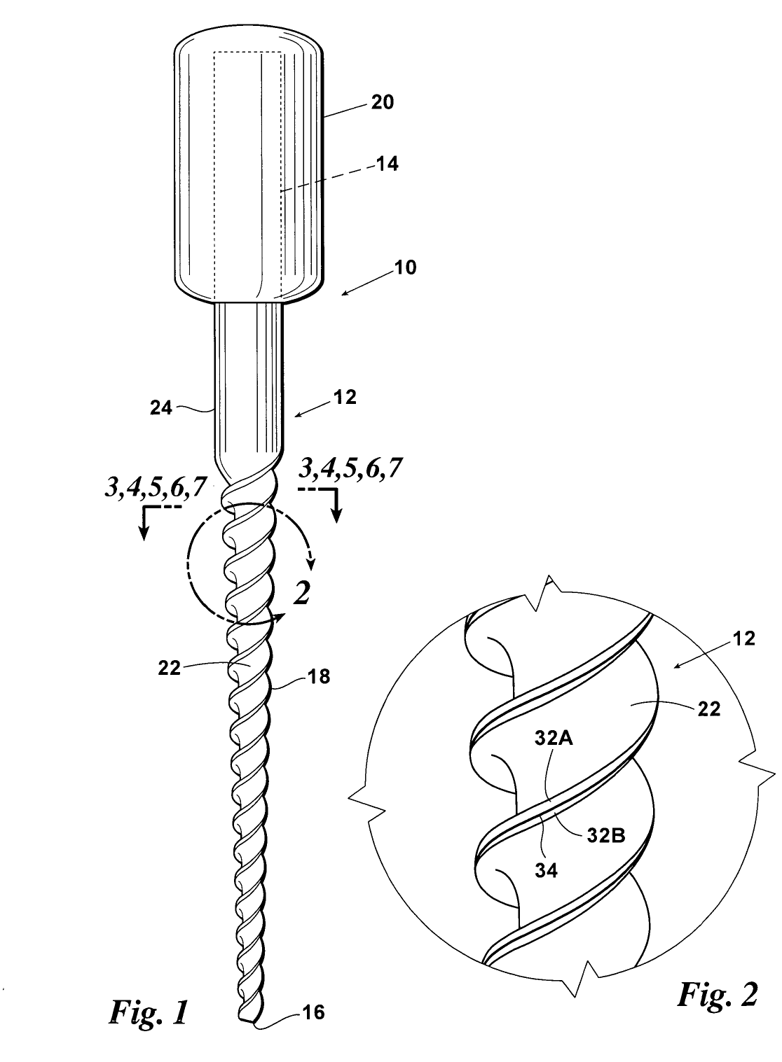

Referring first to FIGS. 1 and 2 the improved dental file of this invention is indicated by the numeral 10. The file includes a shank, generally indicated by 12, which includes a proximal portion 14, a distal end 16 and an intermediate working portion 18. Formed on proximal portion 14 is a handle 20 that is typically held between the thumb and forefinger of the practitioner by which the file is rotated.

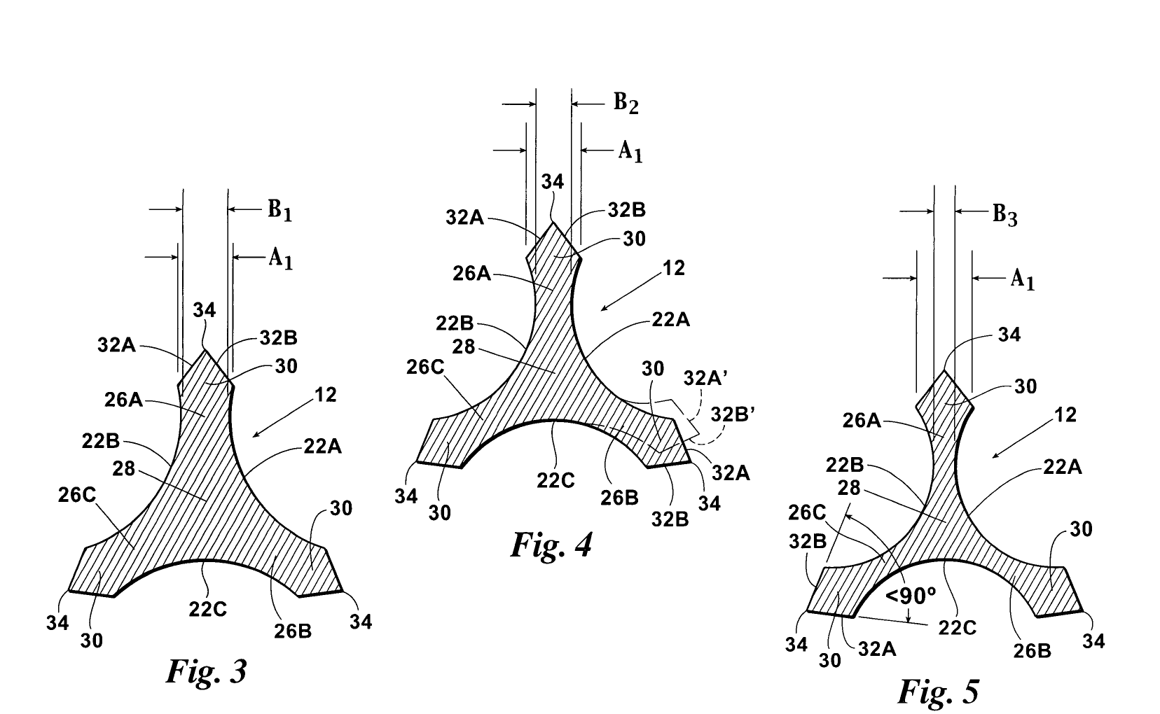

Formed on the working portion 18 of the digital file is at least one helical flute 22. In the preferred embodiment there are a plurality of helical flutes 22. In the illustrations of the invention in FIGS. 3-7 there are three helical flutes 22A, 22B and 22C. While the number of flutes can vary between one and a higher number, typically the preferred number of flutes is illustrated in FIGS. 3 through 7, that is, there are three helical flutes. The flutes start at a position that is spaced from handle 20 and extends to distal end 16. In the illustrated arrangement, the shank 12 has a cylindrical portion 24 that partially extends within handle 20. As seen in FIGS. 3 through 7 that are perpendicular to the longitudinal axis of shank 12, three spiral flutes 22A, 22B and 22C formed on the exterior of the shank three spiral flanges 26A, 26B and 26C. Flanges 26A, 26B and 26C are integrally formed with and extend from shank central core portion 28.

Each of integral flange portions 26A through 26C has adjacent its outer end a flange working portion 30. In the embodiment of FIGS. 3 through 7, each flange working portion 30 is of triangular configuration providing planar surfaces 32A and 32B that intersect to form tip 34. Tip 34 defines a spiraled cutting, scraping or abrading edge. That is, edge 34 of each of the flange working portions 30 forms, in a cross-section of each of the flange working portions 18, a tip 34 but this tip forms a spiraled cutting or shaping edge 34 as seen in FIG. 2.

Each of the flange working portions 30 has a width A as illustrated in FIGS. 3 through 5. Each flange working portion 30 is connected to the shank central core 28 by a flange neck portion 26. An important aspect of the invention is the provision that the width A of each flange working portion 30 is greater than the width B of the flange neck portion 26. These reduced width neck portions 26A, 26B and 26C permit a degree of flexibility of each flange working portion 30 compared to the central core portion 28.

As seen in FIGS. 3, 4 and 5, the depth of each of the spiral flutes 22A through 22C determines the width B of the neck portion 26. As illustrated in FIG. 3, the width B, of each of the neck portions 26A, 26B and 26C is equal, predicated upon the depth of the flutes 22A, 22B and 22C being equal. By varying the depth of the helical flutes 22, the width of the neck portions 26 of each of the helical flutes is varied to thereby dramatically vary the rotational flexibility of the working portion of each spiraled flange relative to core portion 28.

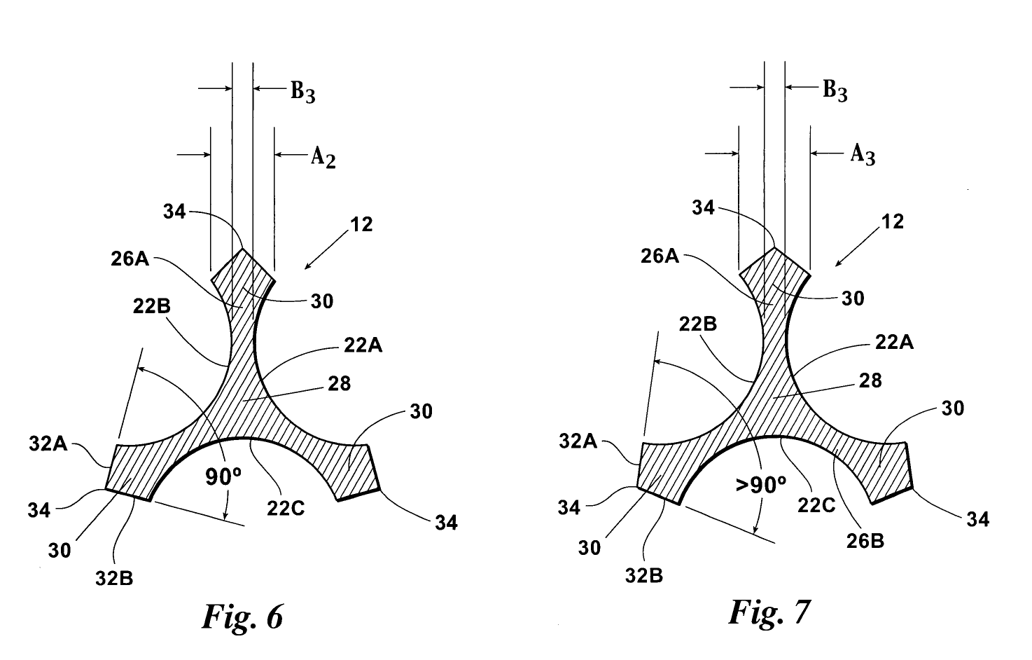

Each flange working portion 30 may vary in geometrical configuration. In FIGS. 3 through 5 each of the flange working portions 30 is substantially similar in its geometrical configuration. That is, the surfaces 32A and 32B of each working portion 30 are substantially the same irrespective of the variation in the flute depth and therefore the variation in the width B and of the neck portions 26A of the three illustrated embodiments. In each of FIGS. 3, 4 and 5, the width A remains substantially equal while the width B varies considerably. In FIGS. 3, 4 and 5 flange outer surfaces 32A and 32B meet at an acute angle, that is, less than 90°. FIG. 6 shows the arrangement wherein the surfaces 32A and 32B meet at apex 34 at a right angle. FIG. 7 shows the embodiment wherein the surfaces 32A and 32B meet at apex 34 forming an obtuse angle, that is, greater than 90°. When the flange working portion 30 is defined by an acute angle as in FIGS. 3, 4 and 5, the apex 34 provides a sharper scraping edge so that the file, when rotated in a root canal has a greater tendency to dig into the surface of the wall of the root canal and therefore to cut away or remove portions of the wall as the file is rotated. On the other hand, when the surfaces 32A and 32B meet at an obtuse angle as in FIG. 7, the cutting action is reduced. Thus, the cutting or abrading action of the files as they are rotated is controllable by the design of shape of the flange working portions.

FIG. 4 illustrates the flexibility of the endodontic file of this invention. In this Figure one of the flange working portions 30 is shown in dotted outline as it would be slightly deflected when the file is rotated clockwise and the tip or spiral end 34 engages an inwardly protruding irregularity in the root canal (not shown) in which the file is situated. This flexibility decreases the possibility of the file becoming rotationally locked as the file is rotated in the process of cleaning or shaping a root canal.

While the invention has been described in a certain degree of particularity, it is manifested that many changes may be made in the details of the construction and the arrangement of the invention without departing from the spirit and scope of this disclosure. The invention is not limited to the exemplary embodiments illustrated herein but is to be limited only by the scope of the attached claim or claims including the full range of equivalency to which each element thereof is entitled.

What is claimed is:

1. A dental reamer/file instrument comprising:
an elongated shank having a proximal end portion, a distal end and a tapered working portion extending from said proximal portion to said distal end;
the external surface of said shank working portion being defined in part by three continuous helical flutes formed into a central core portion of said shank working portion and equally spaced about the circumference of said shank working portion the flutes being spaced apart to define three spiral flanges, each of which is, in a plane perpendicular to the length of said shaft, defined in part by a triangular outer portion having a base width of “A”, an apex of each triangular outer portion forming a cutting/scraping edge, each said triangular outer portion being integrally connected to said central core portion by a reduced width neck portion of width “B” and wherein “A” is greater than “B”, said triangular outer portions having rotational flexibility relative to said shaft central core portion.

2. A dental reamer/file instrument according to claim 1 wherein the depth of said helical flutes are selectably variable, the torsional flexibility of the reamer/file instrument increasing as the depth of said flutes increases.

3. A dental reamer/file according to claim 1 wherein said triangular outer portion forms a right angle apex.

4. A dental reamer/file according to claim 1 wherein said triangular outer portion forms an acute angle apex.

5. A dental reamer/file according to claim 1 wherein said triangular outer portion forms an obtuse angle apex.

6. A dental reamer/file instrument comprising:
an elongated shank having a proximal end portion, a distal end and a tapered working portion extending from said proximal portion to said distal end;
the external surface of said shank working portion being defined, in part, by at least one continuous helical flute formed into a central core portion of said shank working portion to provide a spiraled flange for each helical flute, each spiral flange being defined in part by an outer portion having a width of “A”, each outer portion defining a spiraled cutting or scraping edge, each said outer portion being integrally connected to said central core portion by a reduced width neck portion of width “B” and wherein “A” is greater than “B”, each said outer portion being rotationally flexible within elastic limits relative to said central core portion.
